(19) United States
(12) Patent Application Publication
(10) Pub. No.: US 2023/0276274 A1
(43) Pub. Date: Aug. 31, 2023

(54) WIRELESS LAN FRAME CAPTURE METHOD, WIRELESS LAN FRAME CAPTURE TERMINAL, AND WIRELESS LAN FRAME CAPTURE PROGRAM

(71) Applicant: NIPPON TELEGRAPH AND TELEPHONE CORPORATION, Tokyo (JP)

(72) Inventors: Masayoshi NABESHIMA, Musashino-shi, Tokyo (JP); Hiroshi SAKAMOTO, Musashino-shi, Tokyo (JP); Tomoaki OGAWA, Musashino-shi, Tokyo (JP)

(73) Assignee: NIPPON TELEGRAPH AND TELEPHONE CORPORATION, Tokyo (JP)

(21) Appl. No.: 17/925,263

(22) PCT Filed: May 20, 2020
(86) PCT No.: PCT/JP2020/019972

§ 371 Date: Nov. 14, 2022

(51) Int. Cl. H04W 24/08

(52) U.S. Cl. CPC H04W 24/08; H04W 84/12

(57) ABSTRACT

A wireless LAN frame capture method is to capture a wireless LAN frame transmitted from a target access point. The wireless LAN frame capture method includes: (A) channel scan processing of receiving a wireless LAN frame while sequentially switching a plurality of channels; (B) channel setting processing of setting the channel when an identifier of an access point included in the wireless LAN frame received in the channel scan processing matches a target identifier of the target access point, to a target channel; and (C) frame capture processing of capturing the wireless LAN frame of the target channel.

### TECHNICAL FIELD

The present invention relates to a technique for capturing a wireless LAN (Local Area Network) frame.

### BACKGROUND ART

“Packet capture” is known as a means for maintaining wireless LAN services (see NPL 1). Specifically, when a trouble occurs at an access point, a maintenance person for a wireless LAN service captures a wireless LAN frame transmitted from this access point using a terminal such as a personal computer. Also, the maintenance person analyzes the captured wireless LAN frame to investigate the cause of the trouble occurring at the access point.

### CITATION LIST

### Non Patent Literature

[NPL 1] Daisuke Harada, “Are Mac computers more suitable than Windows computers for investigating Wi-Fi troubles?”, https://xtech.nikkei.com/it/atcl/column/16/083100185/121100022 /, 2017.12.14

### SUMMARY OF THE INVENTION

### Technical Problem

According to a conventional packet capture method, it is necessary to manually designate a channel in use by an access point that is subjected to packet capture.

However, the channel that is used by an access point is not always fixed. For example, there is an access point that has a function of automatically changing the channel in use according to the radio wave condition. Also, access points that correspond to the channel types W53 and W56 have a DFS (Dynamic Frequency Selection) function of automatically changing the channel in use, upon detecting radio waves of a radar that uses the same frequency band. When the channel in use is automatically changed, it is not possible to continue capturing a desired wireless LAN frame in the conventional packet capture method. In this case, a maintenance person needs to search a new channel in use, and manually designate again the new channel in use. As a result, the efficiency of maintenance of the wireless LAN service is reduced.

An object of the present invention is to provide a technique that enables to capture a wireless LAN frame transmitted from an access point, without a user manually designating a channel in use by the access point.

### Means for Solving the Problem

A first aspect relates to a wireless LAN frame capture method for capturing a wireless LAN frame transmitted from a target access point.

The wireless LAN frame capture method includes:
(A) channel scan processing of receiving a wireless LAN frame while sequentially switching a plurality of channels;
(B) channel setting processing of setting the channel when an identifier of an access point included in the wireless LAN frame received in the channel scan processing matches a target identifier of the target access point, to a target channel; and
(C) frame capture processing of capturing the wireless LAN frame of the target channel.

A second aspect relates to a wireless LAN frame capture terminal that captures a wireless LAN frame transmitted from an access point.

The wireless LAN frame capture terminal includes an information processing device.

The information processing device is configured to execute:
(A) channel scan processing of receiving a wireless LAN frame while sequentially switching a plurality of channels;
(B) channel setting processing of setting the channel when an identifier of an access point included in the wireless LAN frame received in the channel scan processing matches a target identifier of the target access point, to a target channel; and
(C) frame capture processing of capturing the wireless LAN frame of the target channel.

A third aspect relates to a wireless LAN frame capture program by which a wireless LAN frame transmitted from an access point is captured.

The wireless LAN frame capture program is executed by a computer and causes the computer to execute:
(A) channel scan processing of receiving a wireless LAN frame while sequentially switching a plurality of channels;
(B) channel setting processing of setting the channel when an identifier of an access point included in the wireless LAN frame received in the channel scan processing matches a target identifier of the target access point, to a target channel; and
(C) frame capture processing of capturing the wireless LAN frame of the target channel.

### Effects of the Invention

According to the present invention, the channel scan processing receives a wireless LAN frame while sequentially switching a plurality of channels. The channel setting processing sets the channel when an identifier included in the received wireless LAN frame matches a target identifier of the target access point, to a target channel. Also, the frame capture processing captures the wireless LAN frame of the target channel. Accordingly, it is possible to capture a wireless LAN frame transmitted from the target access point, without a user manually designating the target channel in use by the target access point. The user does not need to search and designate the target channel in use by the target access point each time. As a result, the efficiency of maintenance of the wireless LAN service is improved.

### BRIEF DESCRIPTION OF DRAWINGS

FIG. 1 is a block diagram illustrating a configuration of a wireless LAN system according to an embodiment of the present invention.

FIG. 2 is a block diagram schematically illustrating an example of a configuration of a wireless LAN frame capture terminal according to the embodiment of the present invention.

FIG. 3 is a block diagram illustrating an example of a functional configuration of the wireless LAN frame capture terminal according to the embodiment of the present invention.

FIG. 4 is a flowchart illustrating processing performed by an information processing device of the wireless LAN frame capture terminal according to the embodiment of the present invention.

FIG. 5 is a flowchart illustrating step S200 (channel scan processing) and step S300 (channel setting processing) in FIG. 4.

FIG. 6 is a flowchart illustrating step S500 (reception time management processing) in FIG. 4.

FIG. 7 is a conceptual diagram illustrating an example of processing performed by the wireless LAN frame capture terminal according to the embodiment of the present invention.

### DESCRIPTION OF EMBODIMENTS

Hereinafter, an embodiment of the present invention will be described with reference to the accompanying drawings.

### 1. Wireless LAN System

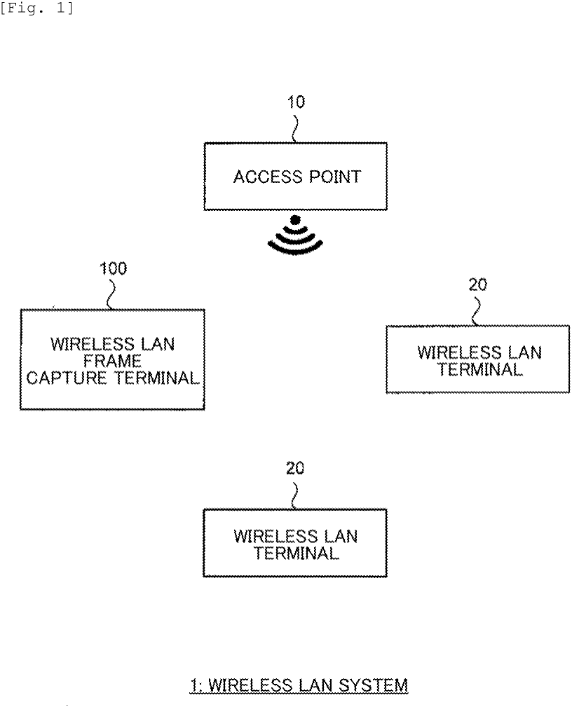

FIG. 1 is a block diagram illustrating a configuration of a wireless LAN system 1 according to the present embodiment. The wireless LAN system 1 includes an access point 10, wireless LAN terminals 20, and a wireless LAN frame capture terminal 100. The access point 10 provides a wireless LAN service. The access point 10 and the wireless LAN terminals 20 perform wireless communication.

The access point 10 may have an automatic channel setting function of automatically changing the channel in use according to the radio wave condition. The access point 10 may correspond to the channel type W53 or W56. In this case, the access point 10 has a DFS function of automatically changing the channel in use, upon detecting radio waves of a radar that uses the same frequency band.

The wireless LAN frame capture terminal 100 has a “packet capture function” of capturing a wireless LAN frame that is transmitted from the access point 10. For example, the wireless LAN frame capture terminal 100 is used to maintain a wireless LAN service. Specifically, if a trouble occurs at the access point 10, a maintenance person for the wireless LAN service captures a wireless LAN frame transmitted from this access point 10, using the wireless LAN frame capture terminal 100. Also, the maintenance person analyzes the captured wireless LAN frame to investigate the cause of the trouble occurring at the access point 10.

The following will describe the wireless LAN frame capture terminal 100 according to the present embodiment in more detail.

### 2. Example of Configuration of Wireless LAN Frame Capture Terminal

The wireless LAN frame capture terminal 100 is a computer. For example, the wireless LAN frame capture terminal 100 is a general-purpose computer such as a personal computer. As another example, the wireless LAN frame capture terminal 100 may be a computer dedicated to packet capture.

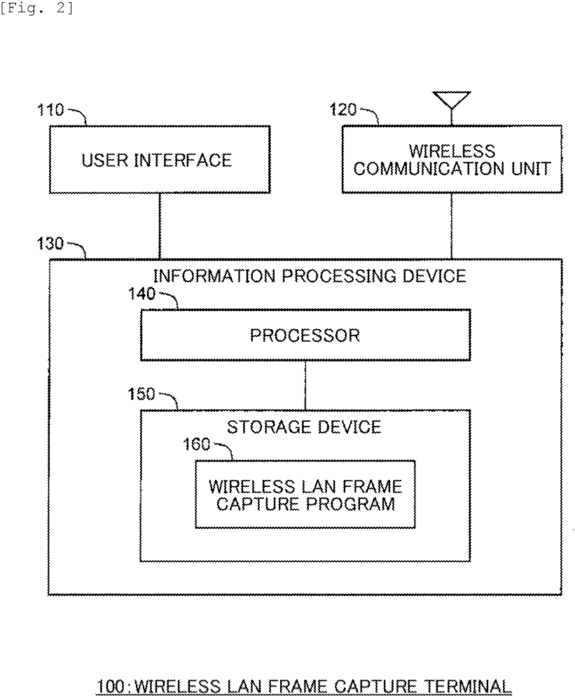

FIG. 2 is a block diagram schematically illustrating an example of a configuration of the wireless LAN frame capture terminal 100 according to the present embodiment. The wireless LAN frame capture terminal 100 includes a user interface 110, a wireless communication unit 120, and an information processing device 130.

The user interface 110 is a user interface for receiving information from a user of the wireless LAN frame capture terminal 100 (e.g., maintenance person for a wireless LAN service), and providing information to the user. Specifically, the user interface 110 includes an input device and an output device. Examples of the input device include a keyboard, a mouse, a touch panel, a switch, and a microphone. Examples of the output device include a display device and a speaker.

The wireless communication unit 120 transmits and receives a wireless LAN frame. For example, the wireless communication unit 120 receives a wireless LAN frame transmitted from the access point 10. The wireless communication unit 120 includes an antenna and a transmission/reception circuit.

The information processing device 130 performs various types of information processing. For example, the information processing device 130 includes a processor 140 and a storage device 150. The processor 140 performs various types of information processing. For example, the processor 140 includes a CPU (Central Processing Unit). The storage device 150 stores various types of information that are needed for processing performed by the processor 140. Examples of the storage device 150 include a volatile memory, a nonvolatile memory, an HDD (Hard Disk Drive), and an SDD (Solid State Drive). As a result of the processor 140 executing a wireless LAN frame capture program 160, which is a computer program, the function of the information processing device 130 (wireless LAN frame capture terminal 100) is realized.

The wireless LAN frame capture program 160 is stored in the storage device 150. The wireless LAN frame capture program 160 may be stored in a computer-readable recording medium. The wireless LAN frame capture program 160 may be provided to the wireless LAN frame capture terminal 100 via a network. In any case, the wireless LAN frame capture program 160 is executed by the processor 140, and realizes the function of the information processing device 130.

The information processing device 130 (processor 140) may be realized by hardware such as an ASIC (Application Specific Integrated Circuit), a PLD (Programmable Logic Device), or a FPGA (Field Programmable Gate Array).

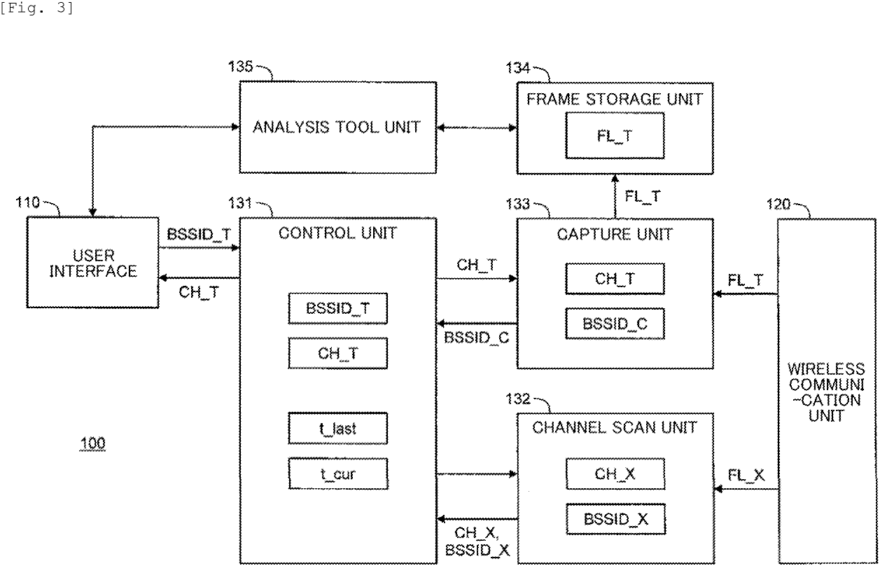

FIG. 3 is a block diagram illustrating an example of a functional configuration of the wireless LAN frame capture terminal 100 according to the present embodiment. The information processing device 130 of the wireless LAN frame capture terminal 100 includes, as functional blocks, a control unit 131, a channel scan unit 132, a capture unit 133, a frame storage unit 134, and an analysis tool unit 135. These functional blocks are realized by, for example, the cooperation of the processor 140 that executes the wireless LAN frame capture program 160, and the storage device 150.

### 3. Processing Flow

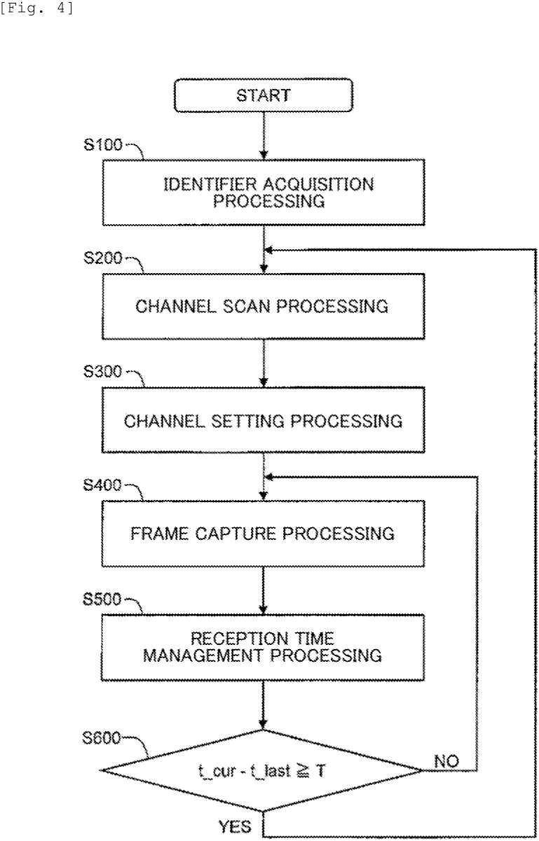

FIG. 4 is a flowchart illustrating processing performed by the information processing device 130 of the wireless LAN frame capture terminal 100 according to the present embodiment. The processing performed by the information processing device 130 according to the present embodiment will be described in detail with reference to FIGS. 3 and 4.

In the following description, a target for packet capture, that is to say, the access point 10 to be observed is referred to as a “target access point 10_T”. Hereinafter, a channel that is in use by the target access point 10_T is referred to as a “target channel CH_T”. The target channel CH_T is not fixed, and may be automatically changed by the target access point 10_T. Hereinafter, a wireless LAN frame that is transmitted/received through the target channel CH_T is referred to as a “wireless LAN frame FL_T”. As will be described below, the information processing device 130 can efficiently capture the wireless LAN frame FL_T of the target channel CH_T transmitted from the target access point 10_T.

### 3-1. Step S100 (Identifier Acquisition Processing)

In step S100, the information processing device 130 acquires identifier designation information that indicates the identifier of the target access point 10_T. For example, the identifier is a BSSID (Basic Service Set Identifier). The identifier of the target access point 10_T is referred to as a “target identifier BSSID_T”.

More specifically, first, a user of the wireless LAN frame capture terminal 100 uses the user interface 110 to designate (input) the target identifier BSSID_T of the target access point 10_T. The control unit 131 acquires and stores the identifier designation information that indicates the target identifier BSSID_T designated by the user. Then, the processing advances to step S200.

### 3-2. Step S200 (Channel Scan Processing)

In step S200, the information processing device 130 receives a wireless LAN frame while sequentially switching a plurality of channels. Here, the plurality of channels are possible channels that can be used by the target access point 10_T. For example, the plurality of channels include a plurality of channels (such as channels 100, 104, 108, 112, 116, 120, and 124) of the channel type W56.

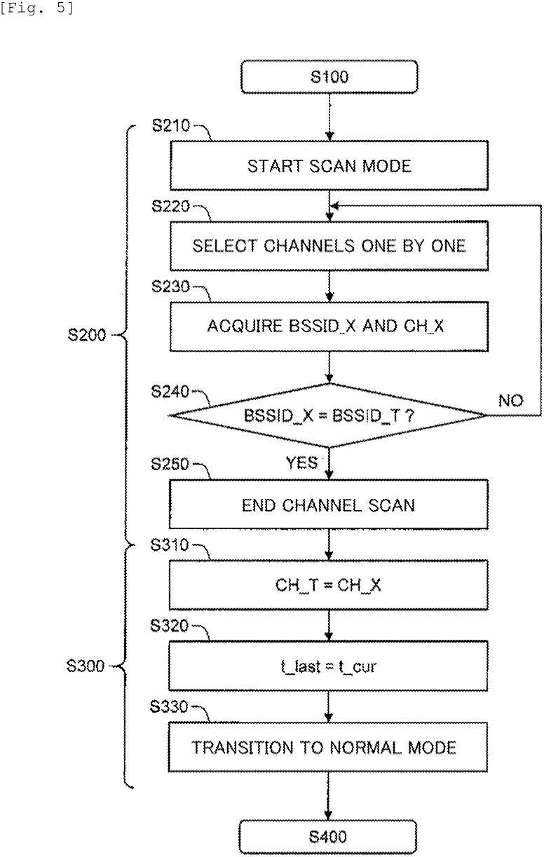

FIG. 5 shows details of step S200. In step S210, the control unit 131 starts to operate in a “scan mode”. The control unit 131 instructs the channel scan unit 132 to start channel scan. The channel scan unit 132 starts to perform channel scan.

In step S220, the channel scan unit 132 selects the plurality of channels one by one. Hereinafter, a selected channel is referred to as a “selected channel CH_X”. The channel scan unit 132 receives a wireless LAN frame FL_X of the selected channel CH_X via the wireless communication unit 120 for a predetermined period of time (e.g., 150 milliseconds). That is to say, the channel scan unit 132 monitors the selected channel CH_X for a predetermined period of time.

In step S230, the channel scan unit 132 acquires an identifier BSSID_X of the access point 10 that is included in the received wireless LAN frame FL_X. The channel scan unit 132 notifies the control unit 131 of the currently selected channel CH_X and the identifier BSSID_X. The control unit 131 acquires information regarding the currently selected channel CH_X and the identifier BSSID_X.

In step S240, the control unit 131 determines whether or not the identifier BSSID_X matches the target identifier BSSID_T of the target access point 10_T. If the identifier BSSID_X does not match the target identifier BSSID_T (No in step S240), the processing returns to step S220. In step S220, the channel scan unit 132 selects a next channel, that is to say, switches the selected channel CH_X. On the other hand, if the identifier BSSID_X matches the target identifier BSSID_T (Yes in step S240), the processing advances to step S250.

In step S250, the control unit 131 determines that the channel scan unit 132 has received the wireless LAN frame FL_T of the target channel CH_T transmitted from the target access point 10_T. Then, the control unit 131 instructs the channel scan unit 132 to end the channel scan. The channel scan unit 132 ends the channel scan. Then, the processing advances to step S300.

### 3-3. Step S300 (Channel Setting Processing)

In step S300, the information processing device 130 sets the selected channel CH_X when the identifier BSSID_X matches the target identifier BSSID_T, to the target channel CH_T.

FIG. 5 also shows details of step S300. In step S310, the control unit 131 sets the selected channel CH_X to the target channel CH_T. The control unit 131 may notify the user of the target channel CH_T via the user interface 110.

In step S320, the control unit 131 sets a last reception time t_last to a current time t_cur. The last reception time t_last refers to a time at which the wireless LAN frame FL_T of the target channel CH_T transmitted from the target access point 10_T was received (captured) last time.

In step S330, the control unit 131 ends the operation in the scan mode, and transitions to a normal mode. Then, the processing advances to step S400.

### 3-4. Step S400 (Frame Capture Processing)

In step S400, the information processing device 130 captures the wireless LAN frame FL_T of the target channel CH_T.

More specifically, the control unit 131 notifies the capture unit 133 of the target channel CH_T. Also, the control unit 131 instructs the capture unit 133 to start packet capture. The capture unit 133 receives and captures the wireless LAN frame FL_T of the target channel CH_T via the wireless communication unit 120. The capture unit 133 stores the captured wireless LAN frame FL_T in the frame storage unit 134. In parallel to step S400, the next step S500 is also performed.

### 3-5. Step S500 (Reception Time Management Processing)

In step S500, the information processing device 130 manages the last reception time t_last at which the wireless LAN frame FL_T of the target channel CH_T transmitted from the target access point 10_T was captured last time.

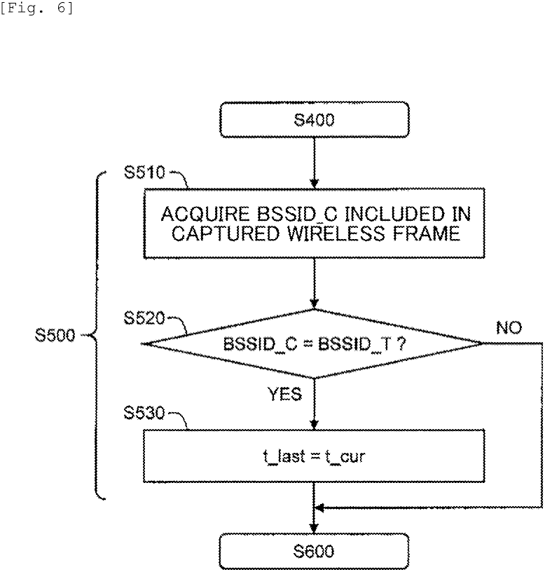

FIG. 6 shows details of step S500. In step S510, the capture unit 133 acquires an identifier BSSID_C of the access point 10 that is included in the captured wireless LAN frame FL_T. The capture unit 133 notifies the control unit 131 of the acquired identifier BSSID_C. The control unit 131 acquires information regarding the identifier BSSID_C.

In step S520, the control unit 131 determines whether or not the identifier BSSID_C matches the target identifier BSSID_T of the target access point 10_T. If the identifier BSSID_C matches the target identifier BSSID_T (Yes in step S520), the processing advances to step S530. On the other hand, if the identifier BSSID_C does not match the target identifier BSSID_T (No in step S520), the processing skips step S530 and advances to step S600.

In step S530, the control unit 131 sets the last reception time t_last to the current time t_cur. That is to say, the control unit 131 updates the last reception time t_last to the current time t_cur. Then, the processing advances to step S600.

### 3-6. Step S600 (Update Determination Processing)

In step S600, the control unit 131 compares an elapsed time (t_cur - t_last) from the last reception time t_last to the current time t_cur with a predetermined threshold T. If the elapsed time is less than the predetermined threshold T (No in step S600), the processing returns to step S400.

On the other hand, if the elapsed time is greater than or equal to the predetermined threshold T (Yes in step S600), there is a high likelihood that the target channel CH_T in use by the target access point 10_T has been changed to another channel. Accordingly, the processing returns to the above-described step S200 to update the target channel CH_T. By executing the above-described step S200 (channel scan processing) and step S300 (channel setting processing) again, the information processing device 130 automatically updates the target channel CH_T. Note that since the target identifier BSSID_T of the target access point 10_T does not change, there is no need to execute step S100 (identifier acquisition processing).

### 3-7. Analysis Processing

The analysis tool unit 135 provides a tool for analyzing the captured wireless LAN frame FL_T. The user can use the analysis tool unit 135 via the user interface 110. The analysis tool unit 135 reads the wireless LAN frame FL_T stored in the frame storage unit 134, and provides information regarding the read wireless LAN frame FL_T to the user via the user interface 110. Also, in response to a user instruction, the analysis tool unit 135 analyzes the wireless LAN frame FL_T, and provides information indicating the analysis result to the user via the user interface 110. The user can investigate the cause of a trouble occurring at the target access point 10_T.

### 4. Effects

As described above, according to the present embodiment, the channel scan processing receives a wireless LAN frame FL_X while sequentially switching a plurality of channels. The channel setting processing sets the selected channel CH_X when the identifier BSSID_X included in the received wireless LAN frame FL_X matches the target identifier BSSID_T of the target access point 10_T, to the target channel CH_T. Also, the frame capture processing captures the wireless LAN frame FL_T of the target channel CH_T.

Accordingly, the information processing device 130 can capture the wireless LAN frame FL_T transmitted from the target access point 10_T, without a user manually designating the target channel CH_T in use by the target access point 10_T. The user does not need to search and designate the target channel CH_T in use by the target access point 10_T each time. As a result, the efficiency of maintenance of the wireless LAN service is improved.

Also, according to the present embodiment, the reception time management processing manages the last reception time t_last at which the information processing device 130 captured the wireless LAN frame FL_T of the target channel CH_T transmitted from the target access point 10_T last time. Also, when the elapsed time (t_cur - t_last) from the last reception time t_last to the current time t_cur is greater than or equal to the predetermined threshold T, the channel scan processing and the channel setting processing are executed again. With this, the target channel CH_T is automatically updated. That is to say, even when the target channel CH_T t in use by the target access point 10_T has been changed, the information processing device 130 can automatically follow a new target channel CH_T and continue the packet capture. The user does not need to manually update the target channel CH_T in use by the target access point 10_T. As a result, the efficiency of maintenance of the wireless LAN service is further improved.

### 5. Processing Example

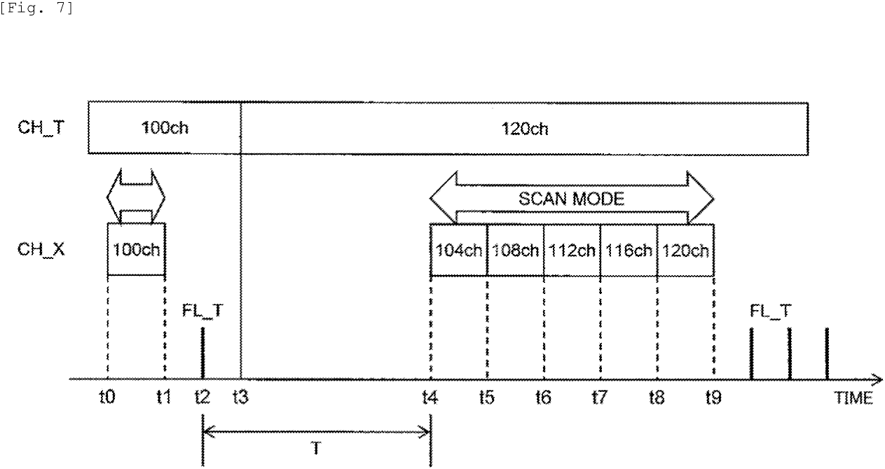

FIG. 7 is a conceptual diagram illustrating an example of processing performed by the wireless LAN frame capture terminal 100 according to the present embodiment. The plurality of channels 100, 104, 108, 112, 116, 120, 124, ... are sequentially selected as the selected channel CH_X. A period of time for which each selected channel CH_X is monitored is 150 milliseconds. It is assumed that the target access point 10_T transmits a wireless LAN frame every 100 milliseconds.

At first, the target access point 10_T uses a channel 100. The user designates the target identifier BSSID_T of the target access point 10_T (step S100).

At time t0, the scan mode is started (step S210). First, the channel 100 is selected as the selected channel CH_X (step S220). The identifier BSSID_X included in the wireless LAN frame FL_X of the channel 100 matches the target identifier BSSID_T of the target access point 10_T (Yes in step S240). Accordingly, the target channel CH_T is set to the channel 100 (step S310). The last reception time t_last is set to the current time t_cur (step S320). At time t1, the scan mode is ended (step S330).

Subsequently, the frame capture processing is executed on the channel 100 (step S400). At time t2, the wireless LAN frame FL_T of the channel 100 is captured. The identifier BSSID_C included in the captured wireless LAN frame FL_T matches the target identifier BSSID_T of the target access point 10_T (Yes in step S520). The last reception time t_last is set to current time t2 (step S530).

At time t3, the channel that is used by the target access point 10_T is changed from the channel 100 to a channel 120. Since the set target channel CH_T remains as the channel 100, the wireless LAN frame FL_T is not captured for a while afterwards, and the last reception time t_last is also not updated.

At time t4, the elapsed time (t_cur - t_last) from the last reception time t_last to the current time t_cur is greater than or equal to the predetermined threshold T (Yes in step S600). As a result, the scan mode is started again (step S210).

At time t4, the channel 104 is selected as the selected channel CH_X (step S220). The wireless LAN frame FL_X of the channel 104 is not received. Alternatively, the identifier BSSID_X included in the wireless LAN frame FL_X of the channel 104 does not match the target identifier BSSID_T of the target access point 10_T (No in step S240). At times t5, t6, and t7, the channels 108, 112, and 116 are respectively selected, and the same results are obtained.

At time t8, the channel 120 is selected as the selected channel CH_X (step S220). The identifier BSSID_X included in the wireless LAN frame FL_X of the channel 120 matches the target identifier BSSID_T of the target access point 10_T (Yes in step S240). Accordingly, the channel 120 is set to the target channel CH_T (step S310). The last reception time t_last is set to the current time t_cur (step S320). At time t9, the scan mode is ended (step S330).

Then, the wireless LAN frame FL_T of the channel 120 is captured (step S400) .

### 6. Modifications

### 6-1. First Modification

In a first modification, the channel scan processing (step S200) is repeated at fixed intervals. More specifically, the reception time management processing (step S500) is omitted. In this case, when the elapsed time (t_cur - t_last) from step S320 to the current time t_cur is greater than or equal to the predetermined threshold T, the channel scan processing (step S200) and onward are executed. As a result, the target channel CH_T is automatically updated at fixed intervals. According to the first modification, the same effects as those of the above-described embodiment can also be achieved.

### 6-2. Second Modification

In a second modification, the channel scan processing (step S200) is executed in response to a user instruction. More specifically, the user inputs a rescan instruction using the user interface 110. For example, the user selects a “rescan” button displayed on the display device. In accordance with the rescan instruction, the channel scan processing (step S200) and onward are executed. Even with the second modification, the user does not need to designate the target channel CH_T in use by the target access point 10_T.

Reference Signs List

| | |
|---|---|
| 1 | Wireless LAN system |
| 10 | Access point |
| 20 | Wireless LAN terminal |
| 100 | Wireless LAN frame capture terminal |
| 110 | User interface |
| 120 | Wireless communication unit |
| 130 | Information processing device |
| 131 | Control unit |
| 132 | Channel scan unit |
| 133 | Capture unit |
| 134 | Frame storage unit |
| 135 | Analysis tool unit |
| 140 | Processor |
| 150 | Storage device |
| 160 | Wireless LAN frame capture program |
| BSSID_T | Target identifier |
| CH_T | Target channel |
| FL_T | Wireless LAN frame |

1. A wireless LAN frame capture method for capturing a wireless LAN frame transmitted from a target access point, the wireless LAN frame capture method comprising:
channel scan processing of receiving a wireless LAN frame while sequentially switching a plurality of channels;
channel setting processing of setting the channel when an identifier of an access point included in the wireless LAN frame received in the channel scan processing matches a target identifier of the target access point, to a target channel; and
frame capture processing of capturing the wireless LAN frame of the target channel.

2. The wireless LAN frame capture method according to claim 1, further comprising:
reception time management processing of managing a last reception time at which the wireless LAN frame of the target channel transmitted from the target access point was captured last time; and
channel update processing of executing again the channel scan processing and the channel setting processing when an elapsed time from the last reception time to a current time is greater than or equal to a predetermined threshold.

3. The wireless LAN frame capture method according to claim 2,
wherein the reception time management processing includes
processing of updating the last reception time to the current time when an identifier of an access point included in the wireless LAN frame captured by the frame capture processing matches the target identifier of the target access point.

4. The wireless LAN frame capture method according to claim 1, further comprising
identifier acquisition processing of acquiring identifier designation information that indicates the target identifier designated by a user, the identifier acquisition processing being executed before the channel scan processing.

5. A wireless LAN frame capture terminal that captures a wireless LAN frame transmitted from an access point, the wireless LAN frame capture terminal comprising an information processing device configured to execute:
channel scan processing of receiving a wireless LAN frame while sequentially switching a plurality of channels;
channel setting processing of setting the channel when an identifier of an access point included in the wireless LAN frame received in the channel scan processing matches a target identifier of the target access point, as a target channel; and
frame capture processing of capturing the wireless LAN frame of the target channel.

6. The wireless LAN frame capture terminal according to claim 5,
wherein the information processing device is configured to further execute:
reception time management processing of managing a last reception time at which the wireless LAN frame of the target channel transmitted from the target access point was captured last time; and
channel update processing of executing again the channel scan processing and the channel setting processing when an elapsed time from the last reception time to a current time is greater than or equal to a predetermined threshold.

7. A wireless LAN frame capture program by which a wireless LAN frame transmitted from an access point is captured,
the wireless LAN frame capture program being executed by a computer and causing the computer to execute:
channel scan processing of receiving a wireless LAN frame while sequentially switching a plurality of channels;
channel setting processing of setting the channel when an identifier of an access point included in the wireless LAN frame received in the channel scan processing matches a target identifier of the target access point, as a target channel; and
frame capture processing of capturing the wireless LAN frame of the target channel.

8. The wireless LAN frame capture program according to claim 7,
wherein the wireless LAN frame capture program causes the computer to further execute:
reception time management processing of managing a last reception time at which the wireless LAN frame of the target channel transmitted from the target access point was captured last time; and
channel update processing of executing again the channel scan processing and the channel setting processing when an elapsed time from the last reception time to a current time is greater than or equal to a predetermined threshold.
